(19) United States
(12) Patent Application Publication
(10) Pub. No.: US 2003/0229532 A1
(43) Pub. Date: Dec. 11, 2003

(54) Systems and methods for soliciting customers at multiple addresses

(76) Inventors: W. Scott Bass, Meridian, ID (US); Heath A. Lindvall, Glen Allen, VA (US); Bradley J. Malestein, Boise, ID (US)

Correspondence Address: Finnegan, Henderson, Farabow,, Garrett & Dunner, L.L.P., 1300 I Street, N.W., Washington, DC, 20005-3315, US

(21) Appl. No.: 10/163,581

(22) Filed: Jun. 7, 2002

(51) Int. Cl. G06F 17/60

(52) U.S. Cl. 705/10

(57) ABSTRACT

Information concerning at least one potential customer is received and then a plurality of addresses for the at least one potential customer are generated. A determination is then made as to whether the number of generated addresses for the at least one potential customer is equal to or below a threshold number. If the number of generated addresses for the potential customer is equal to or below the threshold number, then the potential customer is solicited at each of the generated addresses. If the number of generated addresses for the potential customer is above the threshold number, then using an address selection model a set of addresses equal to the threshold number is selected from the generated addresses and the potential customer is solicited at the selected addresses.

### BACKGROUND OF THE INVENTION

I. Field of the Invention

The present invention generally relates to the field of marketing. More particularly, the invention relates to systems and methods for soliciting customers at multiple locations or addresses.

II. Background and Material Information

Traditionally, direct marketers (such as credit card companies) have solicited potential customers at one address or location. This is because the cost of obtaining multiple addresses for a particular customer typically exceeds any potential gains in revenue from an increased customer response rate. Soliciting a potential customer at only one address is, however, akin to putting all your eggs in one basket. In other words, if the particular address for the potential customer is not correct then the direct marketer will not reach the potential customer or get a response.

Soliciting a potential customer at every address for that customer, however, can also be problematic. For example, where the number of addresses for a particular customer is extremely high, the cost of sending solicitations can substantially increase.

Accordingly, there exists a need for methods and systems for improving the response rate from potential customers without incurring substantial costs.

### SUMMARY OF THE INVENTION

Systems and methods consistent with embodiments of the present invention improve potential customer response rate by sending multiple solicitations to potential customers at multiple addresses, which may be generated using an efficient address selection model.

In accordance with embodiments of the invention, methods for improving customer response rate are provided. According to such methods, information concerning at least one potential customer is received and then a number of addresses for the at least one potential customer are generated. Such methods then determine whether the number of generated addresses for the at least one potential customer is equal to or below a threshold number. If the number of generated addresses for the at least one potential customer is equal to or below the threshold number, then the at least one potential customer is solicited at each of the generated addresses for the at least one potential customer. If the number of generated addresses for the at least one potential customer is above the threshold number, then using an address selection model a set of addresses equal to the threshold number is selected from the generated addresses and the at least one potential customer is solicited at each of the selected addresses.

According to another embodiment of the invention, systems for improving customer response rate are provided. Such systems may include means for receiving information concerning at least one potential customer, and means for generating a number of addresses for the at least one potential customer. Such systems may further include means for determining whether the number of the generated addresses for the at least one potential customer is equal to or below a threshold number. Additionally, the systems may include means for soliciting the at least one potential customer at each of the generated addresses for the at least one potential customer, if the number of generated addresses for the at least one potential customer is equal to or below the threshold number. Also, the systems may include means for selecting a set of selected addresses equal to the threshold number from the generated addresses for the at least one potential customer, if the number of generated addresses for the at least one potential customer is above the threshold number and means for soliciting the at least one potential customer at each of the selected addresses.

Both the foregoing general description and the following detailed description are exemplary and are intended to provide further illustration and explanation of the embodiments of the invention as claimed.

### BRIEF DESCRIPTION OF THE DRAWINGS

The accompanying drawings, which are incorporated in and constitute a part of this specification, illustrate various embodiments and aspects of the present invention. In the drawings:

FIG. 1 illustrates an exemplary system environment, consistent with embodiments of the present invention;

FIG. 2 shows an exemplary address generation server, consistent with embodiments of the present invention;

FIG. 3 shows an exemplary table containing address selection model data, consistent with embodiments of the present invention;

FIG. 4 shows an exemplary address selection model, consistent with embodiments of the present invention; and

FIG. 5 shows a flowchart of an exemplary method for improving customer response rate, consistent with embodiments of the present invention.

### DETAILED DESCRIPTION

Systems and methods consistent with embodiments of the present invention enable a business entity (such as a direct marketer) to improve customer response rates. Improved customer response rates are realized by soliciting a potential customer at multiple addresses. The multiple addresses may be obtained from the direct marketer's own database or from address databases provided by commercial providers, such as Experian. Because in certain situations a potential customer may have several addresses, embodiments of the present invention also provide a method and system for selecting a smaller subset of addresses from the many addresses that the potential customer may have. In one embodiment, this is achieved using an address selection model, which may be built using historical data for a particular market, for example.

Embodiments of the invention may be implemented in various system or network environments. Such environments and applications may be specially constructed for performing the various processes and operations of the embodiments of the invention or they may include a general-purpose computer or computing platform selectively activated or reconfigured by program code to provide the necessary functionality. The systems and methods disclosed herein are not inherently related to any particular computer or other apparatus, and may be implemented by a suitable combination of hardware, software, and/or firmware. For example, various general-purpose machines may be used with programs written in accordance with teachings of the embodiments of the invention, or it may be more convenient to construct a specialized apparatus or system to perform the required methods and techniques.

Embodiments of the invention also relate to computer readable media that include program instruction or program code for performing various computer-implemented operations. The media and program instructions may be those specially designed and constructed for the purposes of the embodiments of the invention, or they may be of the kind well known and available to those having skill in the computer software arts. Examples of program instructions include both machine code, such as produced by compiler, and files containing a high level code that can be executed by the computer using an interpreter.

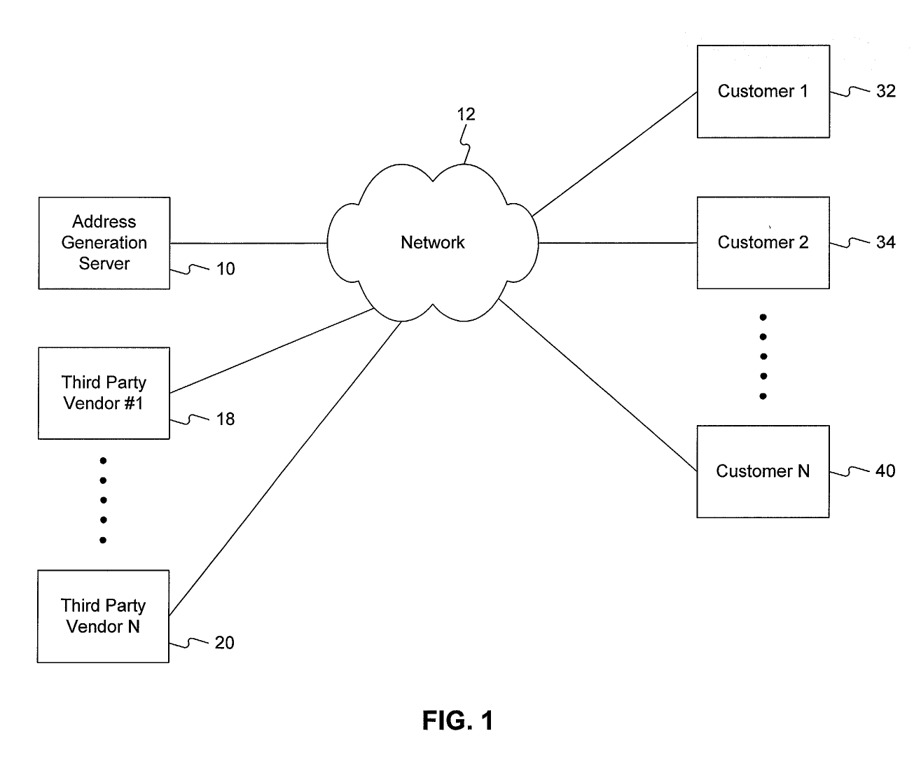

FIG. 1 is an illustration of an exemplary system environment, consistent with embodiments of the present invention. As shown in FIG. 1, the exemplary system environment may include an address generation server 10 connected via a network 12 to third party vendors and customers. Thus, for example, Third Party Vendor #1 18 and Third Party Vendor #N 20 may be connected via network 12 to the address generation server. Similarly, Customer 1 32, Customer 2 34, and Customer N 40 may be connected via network 12 to address generation server 10.

Examples of networks that may be used to receive addresses and send solicitations to customers include public networks such as the Internet, telephony networks, courier networks (e.g., postal service, United Parcel Service, Federal Express, etc.), private networks, virtual private networks, local area networks, metropolitan area networks, wide area networks, ad hoc networks, or any other mechanism for permitting communication between remote sites, regardless of whether the connection is wired or wireless. Thus, the present invention can be used in any environment where information may be exchanged by any means among the various components, including, for example the address generation server, the third party vendors, and the potential customers.

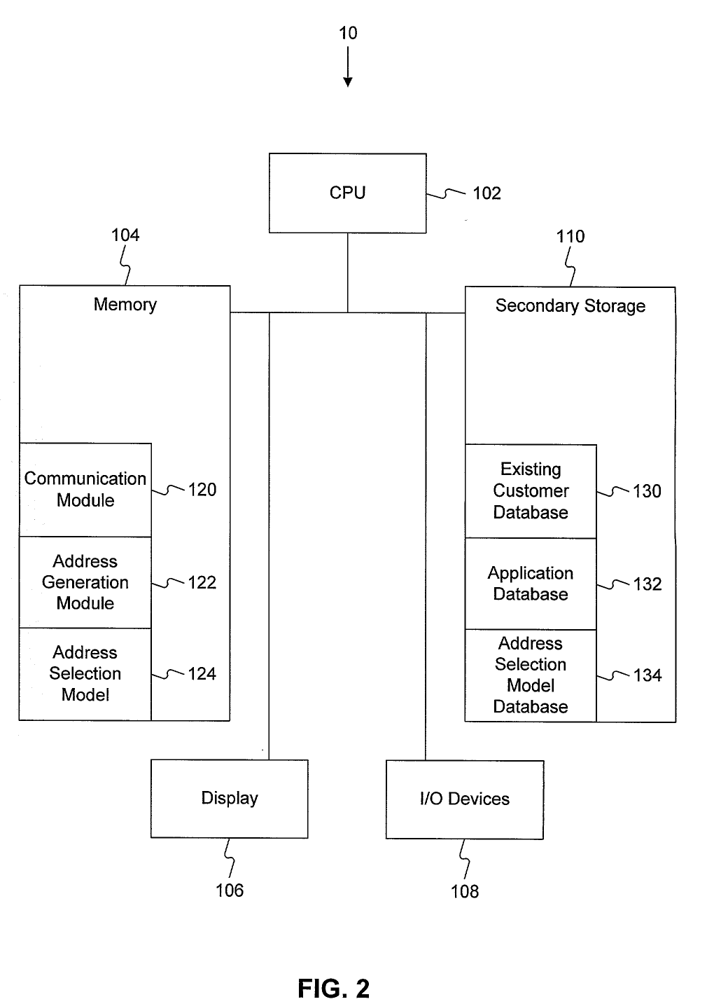

FIG. 2 shows an exemplary address generation server 10, consistent with embodiments of the present invention. Address generation server 10 may include a CPU 102, a memory 104, a display 106, I/O devices 108, and secondary storage 110. Although FIG. 2 depicts only one CPU, one skilled in the art will appreciate that other processors may be used as part of the system. Memory 104 may further include a communication module 120, an address generation module 122, and an address selection model 124. Communication module 120 may, alone or in conjunction with other software, such as an operating system, provide communication ability to the address generation server. Communication module 120 may be implemented in software using any programming language and it may include or interface with program libraries, application program interfaces, operating systems, or other software. Address generation module 122 may generate addresses and may also be used to select a threshold number of addresses, where the generated addresses exceed the threshold number. Address generation module 122 may be implemented in software using any programming language and it may include or interface with program libraries, application program interfaces, operating systems, or other software. Address selection model 124 may comprise logic associated with the selection of the threshold number of addresses. Address selection model 124 may be implemented as a decision tree. Other possible implementations include logistic regression, CART, generalized additive models, bagging, boosting, and neural networks.

Secondary storage 110, which is connected to other parts of the exemplary system of FIG. 2, may be implemented with a storage device, such as a high-density memory or storage device. Secondary storage 110 may include existing customer database 130, application database 132, and address selection model database 134. Existing customer database 130 may contain account information concerning existing customer accounts. Application database 132 may contain addresses corresponding to potential customers, who may have applied for financial accounts, such as credit cards or other types of products and services offered by the direct marketer or a client of the direct marketer. As used herein, the term “address” includes but is not limited to a mailing address, a telephone number, or an electronic mail address.

Secondary storage 110 may be either directly connected to the rest of the system, or indirectly connected via a communication network, such as a local area network, or the Internet. Also, the data residing in the databases and tables stored in secondary storage 110 may be distributed over various databases or tables.

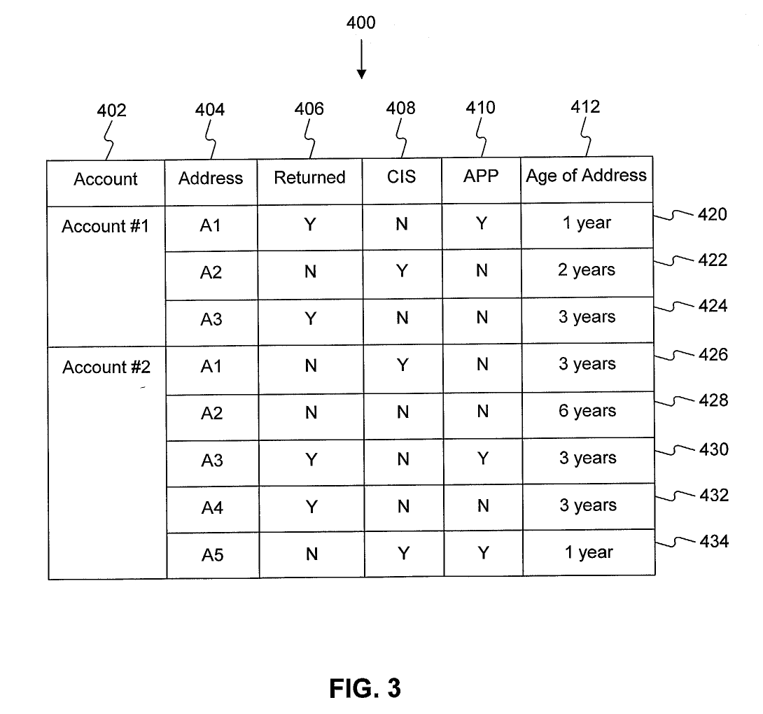

FIG. 3 shows an exemplary table containing address selection model data, consistent with embodiments of the present invention. Table 400 may reside or be stored in a database, such as the address selection model database 134 of FIG. 2. Alternatively or additionally, table 400 may be part of a relational database or any other conventional database arrangement. Table 400 may contain, for example, data generated by sending test solicitations to addresses generated by address generation module 122 of FIG. 2.

Consistent with embodiments of the invention, the data of table 400 may be structured or stored according to various conventional techniques or arrangements. For example, the data be structured or stored using data strings or linked lists. Further, as illustrated in FIG. 3, table 400 may be structured to provide several rows and/or columns of information for customer accounts, such as credit card customer accounts. For example, a column 402 may be provided in table 200 to list account numbers identifying the unique accounts of customers or users. Column 404 may include an address or multiple addresses (if available) for each customer account. Column 406 may include information concerning whether a solicitation sent to a particular address was returned. Thus, for example, where mail sent to a particular address is returned this column may include a Y corresponding to that address for a particular account. Column 408 may include information concerning whether the source of the address is CIS (which may be an in-house customer database). Column 410 may include information regarding whether the source of the address is APP (which may be an in-house credit card application database). Similarly, although not shown, other columns may include information concerning whether the address is from any one of the third party vendors, such as EXP (Experian), EQF (Equifax), or IBB (Acxiom). Also, although not shown, another column may contain addresses for accounts obtained by a addresses may be labeled as being from a source SRC. Column 412 may include information concerning the age of a particular address.

Each of the entries in the columns may be fields containing data representing the value of the corresponding field. Thus, for example, column 412 includes values (e.g., the age of an address corresponding to an address for a particular account) for each corresponding account. The order of the columns in table 400 is merely exemplary and, accordingly, the columns indicated in table 400 may be arranged differently, consistent with embodiments of the present invention.

As further illustrated in FIG. 3, each row of table 400 provides information concerning the various addresses for the customer accounts. Thus, for example rows 420, 422, and 424 contain values corresponding to address information for account number 1. Similarly, rows 426, 428, 430, 432, and 434 contain values corresponding to address information for account number 2. Although only two accounts and their corresponding address information is illustrated in table 400, information concerning any number of accounts may be organized and stored in a similar fashion.

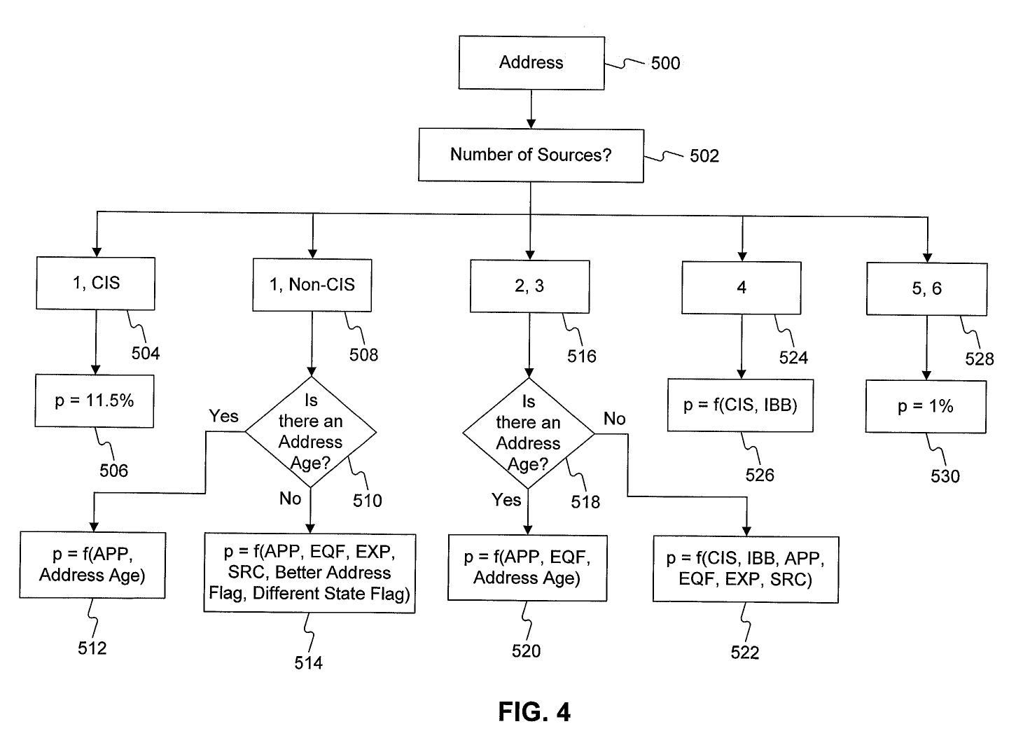

FIG. 4 shows an exemplary address selection model, consistent with embodiments of the present invention. The exemplary address selection model shows one implementation of a decision tree for attaching a probability that mail sent to an address would be returned. Using the address selection model, various probabilities based on the relevant parameters of an address may be calculated. Such parameters address, and the age of the address. Other indicators, such as the quality of an address may also be used. The exemplary address selection model shown in FIG. 4 may be applied to data stored in table 400 of FIG. 3 to arrive at these probabilities. Various statistical or non-statistical techniques, for example, logistic regression, classification and regression techniques, and neural networks may be used. Additionally, CART, generalized additive models, bagging, and boosting may also be used. Thus, for example, each address stored in table 400 may be processed using the exemplary decision tree of FIG. 4.

For an address accessed from the table (step 500), in one embodiment, one may determine the number of sources for that address (step 502). In this example, it may be assumed that the maximum number of sources for an address is six. Of course, a higher or lower maximum number of sources may also be used consistent with the present invention. If the number of sources for the address at issue is one and the address is from CIS (step 504), then in the exemplary model a probability of return (p) of 11.5% may be assigned to such addresses (step 506). This probability may be derived based on experience and/or by applying any one of a probability functions to test data.

If the number of addresses is one, but it is a non-CIS address (step 508), then the exemplary address selection model may determine whether the age of the address is available (step 510). If yes, then the probability of return may be calculated using a function p=f(APP, address age) (step 512). Of course, a similar function may be used to obtain the probability of return for addresses from other databases that also have an address age for the address data stored in them. If, however, address age is not available, then the probability of return may be calculated using another function p=f(APP, EQF, EXP, SRC, better address flag, different state flag) (step 514). The better address flag may be a binary on/off variable that may be used to indicate whether a particular address is a better address than other addresses. An address may be a better address if it is from the CIS database or if it is confirmed by more than two databases. The different state flag may also be a binary on/off variable that may indicate when an address is from a different state from the better address. Of course, more or fewer such variables may be used consistent with embodiments of the present invention.

If the number of sources is either two or three (step 516), then the address selection model may determine whether the age of the address is available (step 518). If yes, then the probability of return may be calculated using a function p=f(APP, EQF, address age) (step 520). If, however, address age is not available then the probability of return may be calculated using another function p=f(CIS, IBB, APP, EQF, EXP, SRC) (step 522).

Referring again to FIG. 4, if the number of sources for an address is four (step 524), then the address selection model may apply another exemplary function p=f(CIS, IBB) (step 526) to determine the probability of return for that address. If however, the number of sources for an address is five or six (step 528), then the address selection model may assign a probability of return of one percent (step 530) to such addresses. Of course, another number may also be assigned. Indeed, the address selection model discussed above is merely exemplary and any logical assignment of probabilities of return may be used to assign such probabilities to addresses based on factors, such as the number of sources for that address, the quality of such sources, and other factors. Such other factors include but are not limited to: 1) elapsed time since the last contact with the potential customer; 2) number of accounts the potential customer already may have with the direct marketer, for example, and the status of those accounts; 3) whether the address vendor provided a telephone number for the potential customer; and 4) whether the address vendor provided employer information for the potential customer.

In one embodiment the probability of return (p) may be calculated by using a function, such as p=X/(1+X). However, depending on the number of address sources, p may be assigned a predetermined value. By way of a non-limiting example, the following logic may be used to calculate p and X:

IF NUMBER OF SOURCES >=5, THEN p=1%
IF NUMBER OF SOURCES = 4, THEN

X = exp (

−1.9404
−1.9097*CIS
−1.1425*IBB
)

IF NUMBER OF SOURCES = 2 OR 3, THEN

IF ADDRESS AGE IS NULL, THEN

X = exp (

.8413
−2.7711*CIS
−.7687*APP
−1.0697*EQF
−1.0231*EXP
−1.5022*IBB
−.3646*SRC
)

IF ADDRESS AGE IS NOT NULL, THEN

X = exp (

.1009
−2.1097*CIS
−.7332*APP
−.6220*EQF
−1.0090*EXP
−1.0628*IBB
−.5050*SRC
+.2266*ADDRESS_AGE

IF NUMBER OF SOURCES = 1, THEN

IF CIS = 1, THEN p = 11.5%
ELSE IF ADDRESS AGE IS NULL, THEN

X = exp (

.1629
−.4113*APP
−.7506*EQF
−.3450*EXP
−.1423*EXP*BETTER_ADDRESS_FLAG
+.3569*EXP*DIFFERENT_STATE_FLAG
−.4925*IBB
−.0412*SRC*BETTER_ADDRESS_FLAG
+.2328*SRC*DIFFERENT_STATE_FLAG
(

ELSE IF ADDRESS AGE IS NOT NULL, THEN

X = exp (

−.6953
−.0767*APP
+.3132*ADDRESS_AGE
)

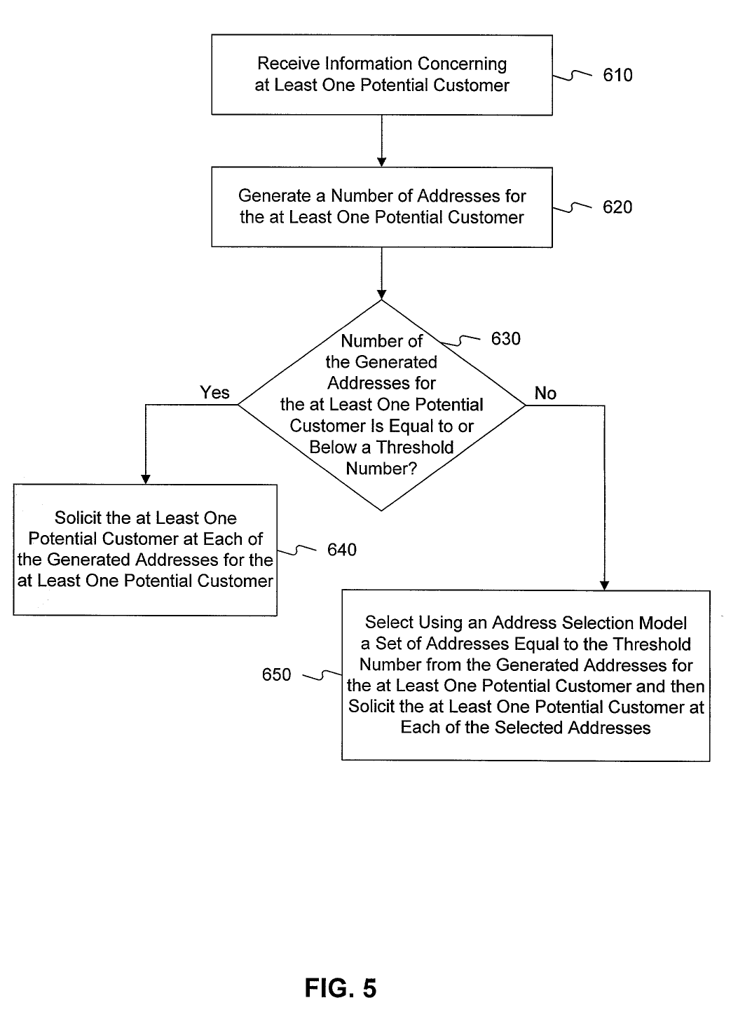

FIG. 5 shows a flowchart of an exemplary method for improving customer response rate, consistent with embodiments of the present invention. The feature and functionality of this exemplary method may be implemented by communication module 120, address generation module 122, and address selection model 124, when executed by CPU 100 (see FIG. 2). In one implementation, communication module 120 may alone or in combination with other modules help send solicitations to potential customers. Further, address generation module 122, alone or in combination with address selection model 124, may help generate addresses for potential customers. These modules and their corresponding functionality may be combined into one module or may be distributed into other modules to perform the steps corresponding to the exemplary method of FIG. 5, consistent with embodiments of the present invention.

As illustrated in FIG. 5, the process begins when information concerning at least one potential customer is received (step 610). Such information may include, for example, merely the name of the potential customer. Alternatively, such information may be more extensive and may include, for example, an address for the potential customer.

Next, a number of addresses for the potential customer may be generated (step 620) using, for example, address generation module 122 of FIG. 2. This step may include searching and retrieving address information concerning the potential customer from: (1) databases owned or operated by the direct marketer (such as existing customer database 130 and application database 132 of FIG. 2), and/or (2) databases owned by third party vendors (such as Experian and Equifax). In one embodiment, only the databases owned by the direct marketer may be used. In an another embodiment, only the databases owned by third party vendors may be used.

Next, in one embodiment, address generation module 122 may determine whether the number of generated addresses for the at least one potential customer is equal to or below a threshold number (step 630). This determination may be performed automatically or made manually by examining the output from the address generation server. In one embodiment, the threshold number may be five. Of course, another threshold number, for example, six, seven, or eight, or any other reasonable number of addresses consistent with the present invention may be used.

If the number of generated addresses for the at least one potential customer is determined to be equal or below the threshold number, then the potential customer may be solicited at each of the generated addresses (step 640). In one embodiment, the potential customer may be solicited at an electronic mail address using, for example, communication module 120 of FIG. 2. Alternatively, the potential customer may be solicited at a mailing address, such as a postal address using convention mail. The potential customer may also be solicited by calling the potential customer at a telephone number for the potential customer. Additionally, when the information concerning the potential customer includes an address, then the potential customer may be solicited at that address as well.

If the number of generated addresses for the potential customer is above the threshold number, then using an address selection model addresses equal to the threshold number may be selected (step 650). As discussed earlier, in one embodiment, an address selection model may be used to calculate the probability of mail being returned for different type of addresses, where such addresses may be from different sources. Additionally, the probability of return may be a function of the number of sources for a particular address. Also, the address selection model may be based on logistic regression, a classification and regression technique, and/or neural networks. Accordingly, as part of this step, each address may be assigned a probability of return based on its qualities, such as the number of sources for the address, the source of the address, and other parameters, such as whether it is a better address. Next, the generated addresses may be ranked based on the probability of return and a subset of those addresses equal to the threshold number may be selected.

Additionally, although the above embodiment calculates a probability of return, in another alternative embodiment a probability of response may be used consistent with the present invention.

Other modifications and embodiments of the invention will be apparent to those skilled in the art from consideration of the specification and practice of the invention disclosed herein. For example, one skilled in the art will appreciate that the systems and methods consistent with the present invention may be distributed among various components over various computers. Further, although embodiments of the invention have been described herein with reference to financial products or services, systems and methods consistent with embodiments of the invention may also be adapted for any other type of service or product.

What is claimed is:

1. A method for improving customer response rate, comprising:
receiving information concerning at least one potential customer;
generating a number of addresses for the at least one potential customer;
determining whether the number of generated addresses for the at least one potential customer is equal to or below a threshold number;
if the number of generated addresses for the at least one potential customer is equal to or below the threshold number, then soliciting the at least one potential customer at each of the generated addresses for the at least one potential customer; and
if the number of generated addresses for the at least one potential customer is above the threshold number, then using an address selection model to select a set of selected addresses equal to the threshold number from the generated addresses for the at least one potential customer and soliciting the at least one potential customer at each of the selected addresses.

2. The method of claim 1 further comprising soliciting the at least one potential customer at an address if the information concerning the at least one potential customer includes the address.

3. The method of claim 1, wherein the plurality of addresses are a plurality of mailing addresses.

4. The method of claim 1, wherein the plurality of addresses are a plurality of telephone numbers.

5. The method of claim 1, wherein the plurality of addresses are a plurality of electronic mail addresses.

6. The method of claim 1, wherein the address selection model is based on logistic regression.

7. The method of claim 1, wherein the address selection model is based on a classification and regression technique.

8. The method of claim 1, wherein the address selection model is based on at least one of neural networks, bagging, boosting, and generalized additive models.

9. The method of claim 6, wherein the logistic regression includes calculating a probability of unavailability of the solicited potential customer for each of the generated plurality of addresses.

10. A system for improving customer response rate, the system comprising:
means for receiving information concerning at least one potential customer;
means for generating a number of addresses for the at least one potential customer;
means for determining whether the number of generated addresses for the at least one potential customer is equal to or below a threshold number;
means for soliciting the at least one potential customer at each of the generated addresses for the at least one potential customer, if the number of generated addresses for the at least one potential customer is equal to or below the threshold number;
means for selecting a set of selected addresses equal to the threshold number from the generated addresses for the at least one potential customer, if the number of generated addresses for the at least one potential customer is above the threshold number; and
means for soliciting the at least one potential customer at each of the selected addresses.

11. The system of claim 10 further comprising means for soliciting the at least one potential customer at an address if the information concerning the at least one potential customer includes the address.

12. The system of claim 10, wherein the plurality of addresses are a plurality of mailing addresses.

13. The system of claim 10, wherein the plurality of addresses are a plurality of telephone numbers.

14. The system of claim 10, wherein the plurality of addresses are a plurality of electronic mail addresses.

15. The system of claim 10, wherein the address selection model is based on logistic regression.

16. The system of claim 10, wherein the address selection model is based on a classification and regression technique.

17. The system of claim 10, wherein the address selection model is based on at least one of neural networks, bagging, boosting, and generalized additive models.

18. The method of claim 15, wherein the logistic regression includes calculating a probability of unavailability of the solicited potential customer for each of the generated plurality of addresses.

19. A computer-readable medium containing instructions for performing a method for improving customer response rate comprising:
receiving information concerning at least one potential customer;
generating a number of addresses for the at least one potential customer;
determining whether the number of generated addresses for the at least one potential customer is equal to or below a threshold number;
if the number of generated addresses for the at least one potential customer is equal to or below the threshold number, then soliciting the at least one potential customer at each of the generated addresses for the at least one potential customer; and
if the number of generated addresses for the at least one potential customer is above the threshold number, then selecting with an address selection model a set of selected addresses equal to the threshold number from the generated addresses for the at least one potential customer and soliciting the at least one potential customer at each of the selected addresses.

20. The computer-readable medium of claim 19 further comprising instructions for soliciting the at least one potential customer at an address if the information concerning the at least one potential customer includes the address.

21. The computer-readable medium of claim 19, wherein the plurality of addresses are a plurality of mailing addresses.

22. The computer-readable medium of claim 19, wherein the plurality of addresses are a plurality of telephone numbers.

23. The computer-readable medium of claim 19, wherein the plurality of addresses are a plurality of electronic mail addresses.

24. The computer-readable medium of claim 19, wherein the address selection model is based on logistic regression.

25. The computer-readable medium of claim 19, wherein the address selection model is based on a classification and regression technique.

26. The computer-readable medium of claim 19, wherein the address selection model is based on at least one of neural networks, bagging, boosting, and generalized additive models.

27. The computer-readable medium of claim 24, wherein the logistic regression includes calculating a probability of unavailability of the solicited potential customer for each of the generated plurality of addresses.
